(19) United States
(12) Patent Application Publication
(10) Pub. No.: US 2016/0006319 A1
(43) Pub. Date: Jan. 7, 2016

(54) TURBINE GENERATOR POWERED BY ROAD EMBEDDED ROLLER

(71) Applicant: James Allen Fimbres, San DIego, CA (US)

(72) Inventor: James Allen Fimbres, San DIego, CA (US)

(21) Appl. No.: 14/728,864

(22) Filed: Jun. 2, 2015

Related U.S. Application Data
(60) Provisional application No. 62/021,467, filed on Jul. 7, 2014.

(51) Int. Cl. H02K 7/18

(52) U.S. Cl. CPC H02K 7/1853

(57) ABSTRACT

A system and method generates electric power by utilizing the kinetic energy of vehicles travelling over a road way. Embodiments include a roller embedded in the road way that is at least partially exposed and disposed to receive vehicle traffic so that vehicles spin the roller which in response provides output torque to a turbine generator that produces electricity for output to a power grid.

### CROSS-REFERENCE TO RELATED APPLICATIONS

This application claims benefit under 35 U.S.C. §119(e) of U.S. Provisional Application having Ser. No. 62021467 filed Jul. 7, 2014, which is hereby incorporated by reference herein in its entirety.

### BACKGROUND

The embodiments herein relate generally to power generation systems, and more particularly, to a turbine generator powered by a road embedded roller.

Current power generation is insufficient to accommodate ever increasing power needs. Current power generation sources are cost inefficient and typically generate power from a single source. As can be seen, there is a need for a system that leverages energy from a dual purpose application.

### SUMMARY

According to one embodiment of the subject technology, a turbine generator system comprises a turbine generator including power output to a controller circuit and a roller coupled to the turbine generator and configured to drive the turbine generator, the roller protruding from a roadway to spin as a vehicle travels over the roadway and the roller.

According to another embodiment of the subject technology, a method of generating power from a roadway comprises providing a roller at least partially exposed in the roadway, the roller being coupled to a turbine generator; receiving a torque output at the turbine generator from the roller; generating electric power at the turbine generator from the torque output of the roller; and providing the generated electric to a power grid.

### BRIEF DESCRIPTION OF THE FIGURES

The detailed description of some embodiments of the present invention is made below with reference to the accompanying figures, wherein like numerals represent corresponding parts of the figures.

FIG. 1 is a schematic view of a turbine generator system in accordance with an exemplary embodiment of the subject technology;

FIG. 2 is a flowchart of a method of producing power in accordance with another exemplary embodiment of the subject technology; and

FIG. 3 is a perspective exploded view of a turbine generator in accordance with another exemplary embodiment of the subject technology.

### DETAILED DESCRIPTION OF CERTAIN EMBODIMENTS

Broadly, embodiments of the subject technology provide power generation from an existing source of unused energy. Aspects leverage the kinetic energy of automobiles on the road that are already being used for transportation and transfer some of that energy to a turbine generator to produce electricity. Since there are so many people driving on roads, there is a vast amount of untapped energy that can now be captured by aspects of the system described herein. The electricity production can be transferred to existing grid systems for use by the general public thereby recapturing lost energy and relieving some of the strain on current energy producers.

The word “exemplary” is used herein to mean “serving as an example or illustration.” Any aspect or design described herein as “exemplary” is not necessarily to be construed as preferred or advantageous over other aspects or designs.

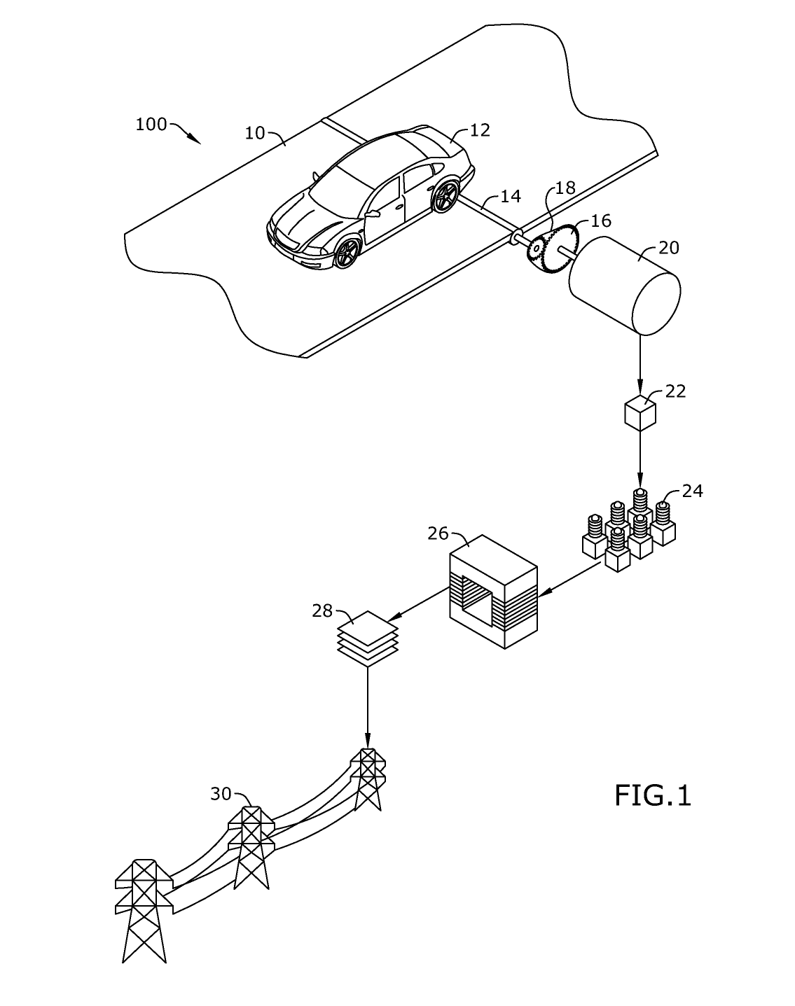

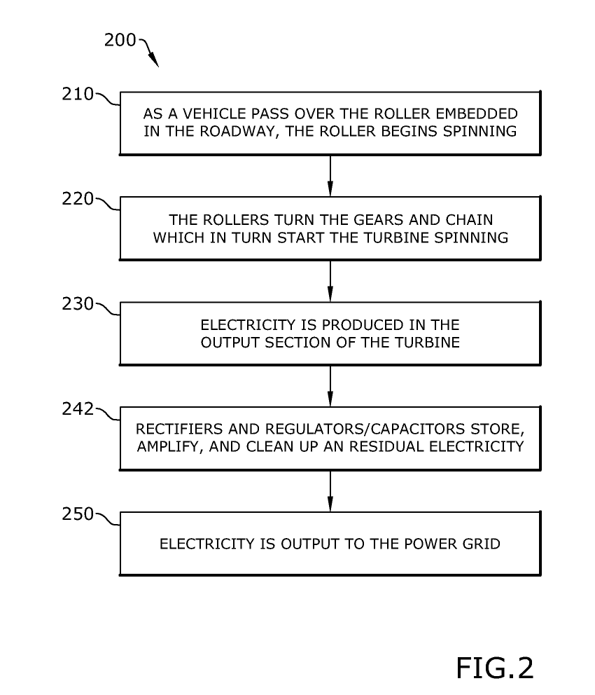

Referring now to FIGS. 1 and 2, an exemplary embodiment of a power generation system 100 (referred to in general as the “system 100”) is shown while referenced concurrently with blocks of a method 200 of generating power from a roadway. The system 100 includes a roller 14 connected to and configured to drive a turbine generator 20. The roller 14 may be for example a carbon fiber or rolled metal cylindrical body protruding from a road 10. In the embodiment shown, the roller 14 traverses the width of the road 10 however it will be understood that the length of the roller 14 may be less than the width of the road 10 or may traverse multiple lanes of a road 10 (for example, as may be used in a multi-lane highway). The roller 14 may be embedded in the road 10 and may be at least partly exposed from the surface of the road 10 so that contact may be made with vehicles 12 travelling over the road 10. In addition, the roller 14 may have sufficient radial clearance from the road 10 so that the roller 14 may spin (210) freely as a vehicle 12 rolls over the roller 14. As the roller 14 spins, it may turn (220) a gear 16 and chain 18 system that converts torque output from the roller 14 to the turbine 20. The turbine 20 may in response produce (230) electric power which may be transferred to a voltage regulator 22. Regulated power may be sent to a capacitor bank 24 and temporarily stored before being sent to a step-up transformer 26. The amount of power drawn from the turbine 20 through the regulator 22, capacitor bank 24, and transformer 26, any amplification, and any residual electricity may be controlled (240) by controller circuits 28 before being output (250) to a power grid 30.

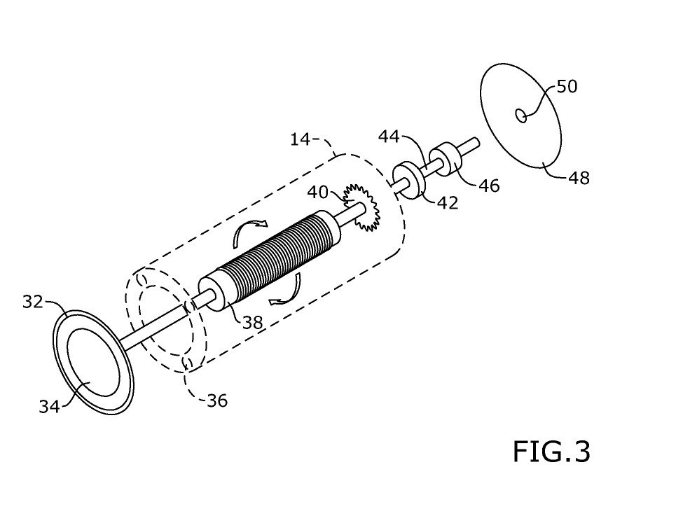

Referring now to FIG. 3, a turbine generator system is shown according to an alternate embodiment of the subject technology. Electrical output means are not shown for sake of illustration. The turbine generator system shown may be positioned in the road 10 (FIG. 1) so that rotation of the roller 14 may operate a generator 38 within the roller 14. The roller 14 may protrude from the road 10 as shown in FIG. 1. Rotation of the roller 14 turns a magnet coupled to a shaft 44. The magnet is hidden from view in FIG. 3 and housed within the body being called out by the reference numeral 38. Turning of the magnet by the shaft 44 creates an electromotive force with windings surrounding the exterior of the generator 38. The generator 38 may be fixedly mounted to a mounting cap 34 on a proximal end (as seen from the perspective of the view of FIG. 3) of the shaft 44. The mounting cap 34 may include a track 32 configured to receive an end of the roller 14. A roller mounted wheel(s) in the track 32 may provide rotation of the roller 14 around the circumference of the mounting cap 34. The distal end of the shaft 44 may be coupled to an end cap 50 which includes a shaft hole 48. The distal end may include a bearing 44 and a bushing 46 to provide rotation support of the shaft 44 in response to rotation of the roller 14. A gear or key 40 may couple the roller 14 to the shaft 44 so that rotation of the roller 14 may be transmitted to the shaft 44. As may be appreciated, providing generation internal of the roller 14 provides a more compact generation system with less components exposed to the environment while still making use of the potential energy of moving automobiles.

Persons of ordinary skill in the art may appreciate that numerous design configurations may be possible to enjoy the functional benefits of the inventive systems. It will be understood for example that the turbine generator 20 may not necessarily be directly adjacent to the road 10 as shown but can be positioned a moderate distance from the road 10. In addition, while the embodiment disclosed shows a single roller 14 to turbine 20 relationship, it will be understood that other embodiments may include multiple rollers 14 jointly connected by to a shared turbine 20 via multiple gear 16 and chain 18 systems. In addition, more or less elements may be present between the roller 14 and the turbine 20 than shown. Thus, given the wide variety of configurations and arrangements of embodiments of the present invention the scope of the present invention is reflected by the breadth of the claims below rather than narrowed by the embodiments described above.

What is claimed is:

1. A turbine generator system, comprising:
a turbine generator including power output to a controller circuit; and
a roller coupled to the turbine generator and configured to drive the turbine generator, the roller protruding from a roadway to spin as a vehicle travels over the roadway and the roller.

2. The turbine generator system of claim 1, wherein the turbine generator is adjacent the roadway.

3. The turbine generator system of claim 1, wherein the roller is a carbon fiber cylindrical body.

4. A method of generating power from a roadway, comprising:
providing a roller at least partially exposed in the roadway, the roller being coupled to a turbine generator;
receiving a torque output at the turbine generator from the roller;
generating electric power at the turbine generator from the torque output of the roller; and
providing the generated electric to a power grid.
